(19) United States
(12) Patent Application Publication
(10) Pub. No.: US 2026/0156341 A1
(43) Pub. Date: Jun. 4, 2026

(54) OPTICAL CONDUCTION ELEMENT, IMAGE CAPTURING MODULE, AND ELECTRONIC DEVICE

(71) Applicant: GUANGDONG OPPO MOBILE TELECOMMUNICATION CORP., LTD., Dongguan (CN)

(72) Inventors: Yi WEI, Dongguan (CN); Yaocheng TAN, Dongguan (CN); Xiangxi WU, Dongguan (CN); Yuchan GAO, Dongguan (CN); Jiawei CHEN, Dongguan (CN); Haiyu ZHANG, Dongguan (CN)

(73) Assignee: GUANGDONG OPPO MOBILE TELECOMMUNICATIONS CORP., LTD., Dongguan (CN)

(21) Appl. No.: 18/967,344

(22) Filed: Dec. 3, 2024

(51) Int. Cl. H04N 23/55; H04N 23/57

(52) U.S. Cl. CPC H04N 23/55; H04N 23/57

(57) ABSTRACT

An optical conduction element includes a body portion and a first light absorbing film. The body portion has a light transmitting surface, a first reflective surface, a second reflective surface, and a bottom surface. The light transmitting surface has a light inlet region and a light outlet region; the first reflective surface is inclined with respect to the light transmitting surface and is disposed corresponding to the light inlet region; the second reflective surface is inclined with respect to the light transmitting surface and is disposed corresponding to the light outlet region; the bottom surface is connected to the first reflective surface and the second reflective surface and is opposite to the light transmitting surface; the bottom surface defines a first groove. The first light absorbing film is arranged covering at least two opposite side walls of the first groove.

### TECHNICAL FIELD

Embodiments of the present disclosure relate to the technical field of image capturing devices, and more specifically, to an optical conduction element, an image capturing module, and an electronic device.

### BACKGROUND

An increasing number of electronic devices, such as smart phones, tablet computers, and e-readers, are arranged image capturing modules to capture images. In order to enable a configuration of a telephoto lens of the image capturing module to be adapted to a structural arrangement of the electronic device and to reduce a thickness of the electronic device, an image capturing module configured with a periscope is provided. The image capturing module configured with the periscope is arranged with an optical conduction element such as a prism to deflect a light propagating path, such that a size of the image capturing module in a thickness direction of the electronic device is reduced. However, in the image capturing module configured with the periscope, since the optical conduction element is arranged, the size of the image capturing module may be increased.

### SUMMARY

The present disclosure provides an optical conduction element, an image capturing module, and an electronic device, so as to solve the technical problem that the size of the image capturing module is increased due to arrangement of the optical conduction element.

In an aspect, the present disclosure provides an optical conduction element including following components.

A body portion has a light transmitting surface, a first reflective surface, a second reflective surface, and a bottom surface. The light transmitting surface has a light inlet region and a light outlet region; the first reflective surface is inclined with respect to the light transmitting surface and is disposed corresponding to the light inlet region; the second reflective surface is inclined with respect to the light transmitting surface and is disposed corresponding to the light outlet region; the bottom surface is connected to the first reflective surface and the second reflective surface and is opposite to the light transmitting surface; the bottom surface defines a first groove.

A first light absorbing film is arranged covering at least two opposite side walls of the first groove.

In another aspect, the present disclosure provides an image capturing module, including a lens, an image sensor, and the optical conduction element as described in the above. A light outlet side of the lens is disposed corresponding to the light inlet region, and the image sensor is disposed corresponding to the light outlet region.

In still another aspect, the present disclosure provides an electronic device, including a housing and the image capturing module as described in the above. The image capturing module is disposed inside the housing, the housing defines a light inlet hole, the light inlet hole is disposed corresponding to the light inlet side of the lens.

### BRIEF DESCRIPTION OF THE DRAWINGS

In order to more clearly illustrate technical solutions in embodiments of the present disclosure or in the related art, the accompanying drawings for describing the embodiments or the related art will be briefly introduced below. Obviously, the accompanying drawings shows only some of the embodiments of the present disclosure. Any ordinary skilled person in the art may obtain other accompanying drawings according to the drawings without making any creative work.

FIG. 1 is a structural schematic view of an electronic device according to an embodiment of the present disclosure.

FIG. 2 is a structural schematic view of an image capturing module according to an embodiment of the present disclosure.

FIG. 3 is a cross-sectional view of an optical conduction element according to an embodiment of the present disclosure.

FIG. 4 is a structural schematic view of an optical conduction element according to an embodiment of the present disclosure.

FIG. 5 is a structural schematic view of a body portion according to an embodiment of the present disclosure.

FIG. 6 is a structural schematic view of the body portion, being viewed from another viewing angle, according to an embodiment of the present disclosure.

FIG. 7 is a cross-sectional view of the optical conduction element according to another embodiment of the present disclosure.

FIG. 8 is a structural schematic view of a third light absorbing film being disposed on a first reflective surface, according to another embodiment of the present disclosure.

FIG. 9 is a structural schematic view of a fifth light absorbing film being disposed on a light transmitting surface, according to another embodiment of the present disclosure.

FIG. 10 is a structural schematic view of other components of the electronic device according to an embodiment of the present disclosure.

### REFERENCE NUMERALS

10, electronic device; 11, image capturing module; 111, lens; 1111, optical lens; 112, image sensor; 113, optical conduction element; 1131, body portion; 1132, first reflective surface; 1133, first reflective region; 1134, second reflective surface; 1135, second reflective region; 1136, light transmitting surface; 1137, light inlet region; 1138, light outlet region; 1139, light absorbing region; 1141, bottom surface; 1142, first groove; 1143, end surface; 1144, second groove; 1145, third groove; 1146, chamfer; 1147, first light absorbing film; 1148, second light absorbing film; 1149, third light absorbing film; 1151, fourth light absorbing film; 1152, fifth light absorbing film; 1153, light absorbing member; 1154, reflective film; 116, infrared filter; 12, housing; 121, light inlet hole.

### DETAILED DESCRIPTIONS

In order to facilitate understanding of the present disclosure, the present disclosure will be described in more detail below by referring to the accompanying drawings. Preferred embodiments of the present disclosure are provided with the accompanying drawings. However, the present disclosure can be achieved in various forms and is not limited to the embodiments described herein. Rather, these embodiments are provided for the purpose of providing a more thorough and comprehensive understanding of the present disclosure.

The “electronic device” in the present disclosure means a device that is capable of receiving and/or transmitting communication signals and is connected by any one or more of the following connection manners:
(1) By means of wired connection, such as by a public switched telephone network (PSTN), a digital subscriber line (DSL), a digital cable, or a direct cable connection;
(2) By wireless interfaces such as a cellular network, a wireless local area network (WLAN), a digital television network such as a DVB-H network, a satellite network, an AM-FM radio transmitter.

An electronic device that is configured to communicate via a wireless interface may be referred to as a “mobile terminal”. Examples of the mobile terminal include, but are not limited to, the following:
(1) a satellite or cellular telephones;
(2) a personal communications system (PCS) terminal that combines a cellular radiotelephone with data processing, facsimile, and data communication capabilities;
(3) a radiotelephones, a pager, an internet/intranet access, a web browser, an organizer, a calendars, a personal digital assistant (PDA) configured with a global positioning system (GPS) receiver;
(4) a conventional laptop and/or palmtop receiver; and
(5) a conventional laptop and/or palmtop radiotelephone transceiver.

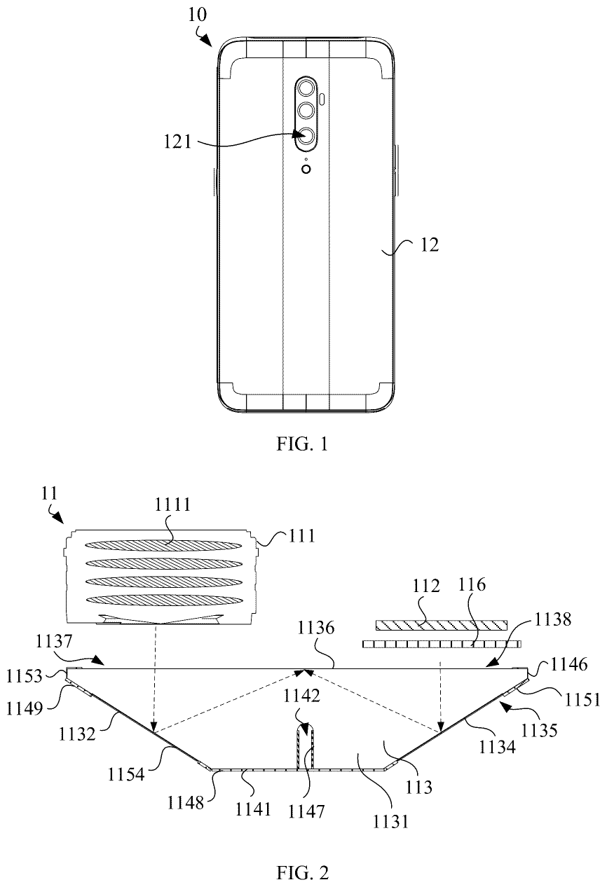

As shown in FIGS. 1 and 2, FIG. 1 is a structural schematic view of an electronic device 10 according to an embodiment of the present disclosure; and FIG. 2 is a structural schematic view of an image capturing module 11 according to an embodiment of the present disclosure. The electronic device 10 includes, but is not limited to, a smart phone, a tablet computer, an e-reader, a wearable device, and any device capable of being configured with the image capturing module 11 to have an image capturing function. In the present embodiment, the electronic device 10 is described as the smart phone as an example.

In some embodiments, the electronic device 10 includes a housing 12 and an image capturing module 11. The image capturing module 11 is arranged inside the housing 12, the electronic device 10 is arranged with the image capturing module 11 to achieve an image capturing function. The image capturing module 11 may be configured to be periscopic to reduce a size of the image capturing module 11 in a thickness direction of the electronic device 10 to optimize a structural arrangement of the electronic device 10 and to reduce a thickness of the electronic device 10. An assembling relationship between the housing 12 and the image capturing module 11 is not limited herein and may be specifically designed according to the structural arrangement of the electronic device 10. For example, in some embodiments, the housing 12 includes a middle frame, a front cover plate, and a rear cover plate. The center frame may be substantially a rectangular frame, the front cover plate and the rear cover plate respectively cover two sides of the center frame, such that the center frame, the front cover plate and the rear cover plate cooperatively define a receiving space. The image capturing module 11 may be received in the receiving space of the housing 12. In the present disclosure, a direction from the front cover plate of the housing 12 towards the rear cover plate of the housing 12 may be regarded as the thickness direction of the electronic device 10.

In some embodiments, the image capturing module 11 includes a lens 111, an image sensor 112, and an optical conduction element 113. The lens 111 is configured to collect light, the lens 111 may include a plurality of optical lenses 1111, each of the plurality of optical lenses 1111 has an optical focal length. The plurality of optical lenses 1111 operate cooperatively to correct aberration while collecting the light, such that imaging quality of the image capturing module 11 is improved. The image sensor 112 includes, but is not limited to, a charge coupled device (CCD) or a complementary metal-oxide semiconductor (CMOS) sensor. The optical conduction element 113 is configured to conduct the light from the lens 111 to the image sensor 112 to form an image, such that the electronic device 10 achieves the image capturing function. In some embodiments, the housing 12 defines a light inlet hole 121 extending through the housing. When the image capturing module 11 is received in the housing 12, a light inlet side of the lens 111 corresponds to the light inlet hole 121 so as to collect the light entering from the light inlet hole 121. An axial direction of the lens 111 may be substantially parallel to the thickness direction of the electronic device 10. By arranging the optical conduction element 113 to deflect a light propagating path while conducting the light, a periscopic configuration is achieved, such that the size of the image capturing module 11 in the thickness direction of the electronic device 10 is reduced. In addition, by arranging the lens 111 on the light inlet side of the optical conduction element 113, the light inlet hole 121 can correspond to the light inlet side of the lens 111, such that the light inlet hole 121 may be configured to be circular to be adapted with other holes of the electronic device 10. Compared to the conventional technical solution in which the light inlet hole is configured to be square to be adapted to a shape of a prism, the circular light inlet hole in the present application enables the electronic device 10 to have a more aesthetic appearance.

The lens 111 may include a plurality of optical lenses 1111, each of the plurality of optical lenses 1111 has the optical focus, and the number of the plurality of optical lenses 1111 and a type of each of the plurality of optical lenses 1111 are not limited herein. In some embodiments, the lens 111 sequentially includes, along an optical axis, four optical lenses 1111 that are spaced apart from each other. A first optical lens 1111 of the lens 111 is located farthest away from the optical conduction element 113 and may be made of glass and processed and molded by grinding. The first optical lens 1111 is substantially configured to correct the aberration and to eliminate a temperature drift. The other three optical lenses 1111 of the lens 111 may be made of plastic and processed and molded by injection molding. The other three optical lenses 1111 are substantially configured to correct the aberration. It is understood that the present embodiment only lists materials and processing methods of the above optical lenses 1111, but does not limit the materials and the processing methods. The materials and the processing methods of the above optical lenses 1111 may be determined by any ordinary skilled person in the art according to the actual needs.

As shown in FIG. 2, in some embodiments, the axis of the lens 111 is sustainably parallel to an axis of the image sensor 112. The optical conduction element 113 is configured to be capable of deflecting the light propagating path by 180°. The optical conduction element 113 has a light inlet region 1137 configured to receive light emitted from the lens 111 and a light outlet region 1138 configured to output the light to the image sensor 112, and the light inlet region 1137 and the light outlet region 1138 may be oriented to a same side. In some embodiments, the light inlet region 1137 is disposed corresponding to a light outlet side of the lens 111 and is configured to receive light emitted from the lens 111. The light outlet region 1138 is disposed corresponding to a light sensing side of the image sensor 112 and is configured to output the light from the optical conduction element 113 to the image sensor 112. In some embodiments, the light inlet region 1137 and the light outlet region 1138 are coplanar, and a plane in which the light inlet region 1137 and the light outlet region 1138 are located is substantially perpendicular to the axis of the lens 111 and the axis of the image sensor 112.

To be noted that the optical conduction element 113 can deflect the light propagating path by 180°, such that the lens 111 and the image sensor 112 can be disposed on a same side of the optical conduction element 113, and therefore, the lens 111 and the image sensor 112 are at least partially overlapped with each other in an optical axial direction of the lens 111. In this way, the size of the image capturing module 11 in the thickness direction of the electronic device 10 is reduced, a space occupied by the image capturing module 11 in the thickness direction of the electronic device 10 is reduced. In the present application, the axis of the image sensor 112 may be perpendicular to the light sensing surface of the image sensor 112.

In some embodiments, the optical conduction element 113 is configured to be able to reflect the light emitted from the lens 111 for at least three times to direct light to propagate to reach the image sensor 112. In this way, the light propagating path at a rear side of the lens 111 is extended, enabling the optical conduction element 113 to adapt to a telephoto configuration of the lens 111. While a sufficient optical magnification is achieved, the periscope configuration is also achieved, such that the space occupied by the image capturing module 11 is reduced.

In some embodiments, a body portion 1131 of the optical conduction element 113 has a first reflective surface 1132, a second reflective surface 1134, and a light transmitting surface 1136. The light inlet region 1137 and the light outlet region 1138 are both arranged on the light transmitting surface 1136. In other words, different regions of the light transmitting surface 1136 respectively face the lens 111 and the image sensor 112. The first reflective surface 1132 is inclined with respect to the light transmitting surface 1136 and is disposed corresponding to the light inlet region 1137. The second reflective surface 1134 is inclined with respect to the light transmitting surface 1136 and is disposed corresponding to the light outlet region 1138. At least a portion of the light from the lens 111 enters the optical conduction element 113 from the light inlet region 1137 and is directed to the first reflective surface 1132. The first reflective surface 1132 reflects the at least the portion of the light reaching the first reflective surface 1132 to propagate to reach the light transmitting surface 1136. The light transmitting surface 1136 can reflect the at least the portion of the light, which is directed from the first reflective surface 1132 to reach the light transmitting surface 1136, to propagate to reach the second reflective surface 1134. The second reflective surface 1134 reflects the at least the portion of the light, which is reflected from the light transmitting surface 1136 to the second reflective surface 1134, to propagate to reach the light outlet region 1138. In this way, the at least the portion of the light is output from the light output region 1138 out of the optical conduction element 113 to reach the image sensor 112. According to the above description, the light transmitting surface 1136 may be substantially perpendicular to the axis of the lens 111 and the axis of the image sensor 112.

In some embodiments, each of an angle between the first reflective surface 1132 and the light-transmitting surface 1136 and an angle between the second reflective surface 1134 and the light-transmitting surface 1136 is greater than or equal to 25° and less than or equal to 35°, which may be 32.5°, for example. In this way, an efficiency and accuracy of the first reflective surface 1132, the second reflective surface 1134, and the light-transmitting surface 1136 in reflecting light may be improved, such that the optical conduction element 113 can successfully deflect the light propagating path by 180°.

The optical conduction element 113 in the present embodiment reflects the at least the portion of the light for three times to direct the light to reach the image sensor 112. In this way, the optical conduction element 113 is applicable to the telephoto configuration of the lens 111. Based on the periscopic configuration in combination with the telephoto configuration of the lens 111, the size of the image capturing module 11 in the thickness direction of the electronic device 10 is reduced. For example, the optical conduction element 113 is applicable to a lens 111 having a 2 times to 4 times (equivalent focal lengths of approximately 40 mm to 90 mm) magnification. When the lens 111 of the image capturing module 11 has a higher magnification, the optical conduction element 113 may deflect the light for a greater number of times to further increase the light propagating path in the optical conduction element 113, such that the telephoto configuration of the lens 111 is applicable.

It is noted that the first reflective surface 1132 and the second reflective surface 1134 may be connected to each other, i.e., the optical conduction element 113 may be substantially in a shape of a prism. As shown in FIG. 2, in some embodiments, the optical conduction element 113 may further have a bottom surface 1141 connected to the first reflective surface 1132 and the second reflective surface 1134. The bottom surface 1141 is opposite to the light transmitting surface 1136. For example, the bottom surface 1141 is substantially parallel to the light transmitting surface 1136, and in this case, a cross section of the optical conduction element 113 may be substantially isosceles trapezoidal. Of course, the bottom surface 1141 shall be disposed at a position avoiding an effective field of view range of the first reflective surface 1132 and the second reflective surface 1134, or a portion of the bottom surface 1141 is disposed corresponding to stray light at an edge of the effective field of view, such that normal imaging of the image capturing module 11 is not affected. The bottom surface 1141 of the optical conduction element 113 may be formed by performing a cutout on the prism or may be formed directly in a process of injection molding. As long as the image quality of the image capturing module 11 is not affected, compared to the prism, arranging the bottom surface 1141 can reduce the size of the optical conduction element 113 in the optical axial direction of the lens 111, such that the size of the image capturing module 11 in the thickness direction of the electronic device 10 is reduced.

In some embodiments, the body portion 1131 of the optical conduction element 113 may be the prism. The first reflective surface 1132, the second reflective surface 1134, the light transmitting surface 1136, and the bottom surface 1141 are all arranged on the body portion 1131. A material of the body portion 1131 includes, but is not limited to, glass or plastic. A refractive index of the body portion 1131 may be in a range of 1.5 to 1.9, such that the light propagating path can be effectively deflected, and the periscopic configuration of the image capturing module 11 is achieved. For example, a material of the body portion 1131 may be glass, and the refractive index of the body portion 1131 may be 1.61.

Further, as shown in FIGS. 2, 3, and 4, in some embodiments, the body portion 1131 has two end surfaces 1143 opposite to each other. Both of the two end surfaces 1143 are connected to the first reflective surface 1132 and the second reflective surface 1134. The bottom surface 1141 is connected to both of the two end surfaces 1143. The bottom surface 1141 defines a first groove 1142. A direction from the bottom surface 1141 towards the light transmitting surface 1136 is considered as a depth direction of the first groove 1142. The first groove 1142 extends in a direction of a line connecting the two end surfaces 1143. The optical conduction element 113 further includes a first light absorbing film 1147, the first light absorbing film 1147 covers at least two opposite side walls of the first groove 1142. When the two opposite side walls of the first groove 1142 have curved surfaces and are connected to each other, the first light absorbing film 1147 may cover and may be connected to the curved surfaces of the two side walls. A material of the first light absorbing film 1147 includes, but is not limited to, any applicable light absorbing material having a light absorbing effect, such as ink.

The above-described optical conduction element 113, the light inlet region 1137 and the light outlet region 1138 are arranged on the light transmitting surface 1136, such that the light transmitting surface 1136 is substantially perpendicular to the thickness direction of the electronic device 10. When an area of the light inlet region 1137 and the light outlet region 1138 needs to be increased in order to increase an aperture of the image capturing module 11, the size of the optical conduction element 113 is increased substantially in a direction perpendicular to the thickness direction of the electronic device 10. In this way, the size of the optical conduction element 113 in the thickness direction of the electronic device 10 is not increased, such that the image capturing module 11 can have a larger aperture and occupies a smaller space. In addition, the first groove 1142 is defined in the bottom surface 1141, and the first light absorbing film 1147 is arranged on two opposite side walls of the first groove 1142. In this way, the first groove 1142 can block and absorb light outside of the light through aperture, stray light and interfering light components in the optical conduction element 113 are reduced, and the imaging quality is improved.

In some embodiments, each of the two opposite side walls of the first groove 1142 and a bottom wall having the curved surface may be configured as a diffuse reflective surface, such as a frosted surface or a matte surface. The first light absorbing film 1147 covers the diffuse reflective surface of the first groove 1142. The diffuse reflective surface of the first groove 1142 can diffusively reflect light directed to the two side walls and the bottom wall of the first groove 1142 to reduce brightness of light, such that the light is more easily absorbed by the first light absorbing film 1147, and brightness of the stray light or the interfering light that is not absorbed by the first light absorbing film 1147 is reduced, such that an effect caused by the stray light on the imaging quality is reduced.

As shown in FIGS. 5, 6, and 7, in some embodiments, one of the two end surfaces 1143 of the body portion 1131 defines a second groove 1144, and the other one of the two end surfaces 1143 of the body portion 1131 defines a third groove 1145. Each of the second groove 1144 and the third groove 1145 extends in a direction from the bottom surface 1141 towards the light transmitting surface 1136. An extending direction of a connection line between the two end surfaces 1143 may be regarded as a depth direction of the second groove 1144 and the third groove 1145. The first light absorbing film 1147 also covers at least opposite side surfaces of the second groove 1144 and opposite side surfaces of the third groove 1145. Due to arranging the first light absorbing film 1147, the first groove 1142, the second groove 1144, and the third groove 1145 all can absorb light. The first groove 1142, the second groove 1144, and the third groove 1145 cooperatively define an aperture range of the optical conduction element 113 for the light to pass through. Light reaching the side surfaces of the first groove 1142, the second groove 1144, and the third groove 1145 is absorbed by the first light absorbing film 1147. Light reaching the aperture range defined by the first groove 1142, the second groove 1144, and the third groove 1145 can pass through the aperture range. By defining the second groove 1144 and the third groove 1145 to operate cooperatively with the first groove 1142, the interfering light or the stray light outside the light through aperture range can be absorbed optimally, the interfering light and the stray light components in the optical conduction element 113 are reduced, and the imaging quality of the image capturing module 11 is improved.

In some embodiments, two ends of the first groove 1142 are respectively communicated with the second groove 1144 and the third groove 1145. The first groove 1142, the second groove 1144, and the third groove 1145 are communicated to each other to form an opening unidirectionally facing towards the light transmitting surface 1136. Of course, each of the opposite side walls of the second groove 1144, the opposite side walls of the third groove 1145, and the bottom surface 1141, which has the curved surface, may be configured to have the diffuse reflective surface, such as the matte surface or the frosted surface. In this way, the stray light and the interfering light components are reduced, the brightness of the stray light and the interfering light is reduced, and the imaging quality of the image capturing module 11 is improved. It is understood that a depth of the first groove 1142, a depth of the second groove 1144, and a depth of the third groove 1145 may be determined according to the size of the optical conduction element 113 and requirements of the light-through aperture and an aperture size of the image capturing module 11. In some embodiments, each of the depth of the first groove 1142 occupies ¼ to ½ of a height of the optical conducting element 113, and the depth of the second groove 1144 and the depth of the third recess groove occupy ¼ to ⅓ of a length of the optical conducting element 113. A size of the body portion 1131 in a direction from the light transmitting surface 1136 pointing towards the bottom surface 1141 may be regarded as the height of the optical conduction element 113, i.e., the size of the body portion 1131 in the thickness direction of the electronic device 10. The size of the body portion 1131 in the direction of the connection line between the two end surfaces 1143 may be regarded as the length of the optical conduction element 113. In this way, the first light absorbing film 1147 has a sufficient coverage area to effectively absorb the stray light and the interfering light, and at the same time, the optical conduction element 113 has a sufficient light-through aperture to meet requirements for imaging.

A width of the first groove 1142, a width of the second groove 1144, and a width of the third groove 1145 may be determined based on a width of a machining tool and an inking process for arranging the first light absorbing film 1147, as long as the first light absorbing film 1147 can be smoothly arranged within and cover the first groove 1142, the second groove 1144, and the third groove 1145. In some embodiments, each of the width of the first groove 1142, the width of the second groove 1144, and the width of the third groove 1145 is in a range of 0.2 mm to 0.8 mm, which may be 0.2 mm, 0.5 mm, or 0.8 mm, and so on.

In some embodiments, the optical conduction element 113 further includes a second light absorbing film 1148. The second light absorbing film 1148 is disposed on the bottom surface 1141 of the body portion 1131. The second light absorbing film 1148 may cover the entire bottom surface 1141, and a material of the second light absorbing film 1148 may be any applicable material having proper light absorbing ability, such as ink. The second light absorbing film 1148 can effectively absorb light that reaches the bottom surface 1141, preventing the light from reflecting at the bottom surface 1141 to form the stray light, such that the stray light and the interference light components are reduced, and the imaging quality of the image capturing module 11 is improved. In some embodiments, the bottom surface 1141 is configured as the diffuse reflective surface, including but not limited to the matte surface or the frosted surface. In this way, the bottom surface 1141 can diffusively reflect the light reaching the bottom surface 1141, brightness of the light is reduced. Therefore, the light can be absorbed by the second light absorbing film 1148 more easily, and brightness of the light reflected by the bottom surface 1141 is reduced, and the brightness of the stray light in the optical conductive element 113 is reduced, preventing the stray light from affecting the imaging quality of the image capturing module 11.

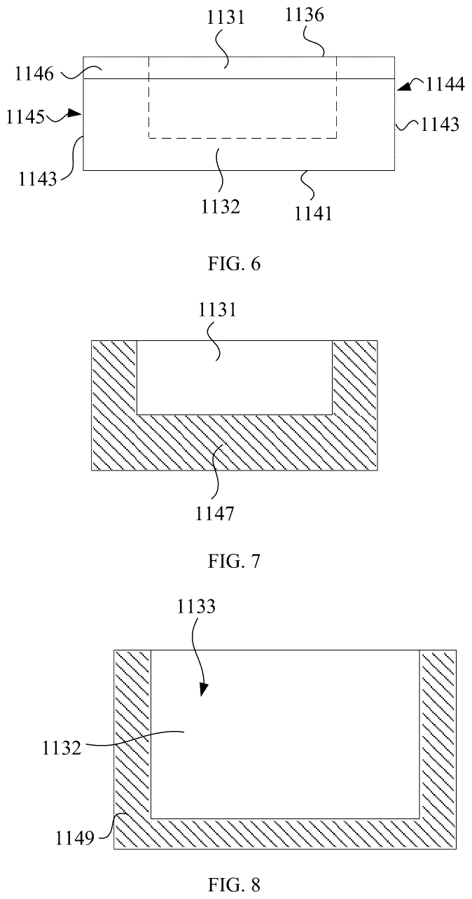

Two opposite edges of the light transmitting surface 1136 may be connected to the first reflective surface 1132 and the second reflective surface 1134, respectively. As shown in FIG. 2 and FIG. 6, in some embodiments, a chamfer 1146 is arranged for transition at each of a transition between the light transmitting surface 1136 and the first reflective surface 1132 and a transition between the light transmitting surface 1136 and the second reflective surface 1134. A surface of the chamfer 1146 may be inclined with respect to or perpendicular to the light transmitting surface 1136. Compared to the technical solution in which the first reflective surface 1132 and the second reflective surface 1134 are directly connected to the light transmitting surface 1136, the chamfer 1146 is arranged to prevent the two ends of the body portion 1131 from being excessively sharp and fragile, such that a risk of sharp corners of the two ends of the optical conduction element 113 being chipped, due to scraping during production or assembling, is reduced.

In some embodiments, the optical conduction element 113 further includes a light absorbing member 1153 disposed at the chamfer 1146 between the light transmitting surface 1136 and the first reflective surface 1132 and another light absorbing member 1153 disposed at the chamfer 1146 between the light transmitting surface 1136 and the second reflective surface 1134. A material of each light absorbing member 1153 includes, but is not limited to, a material such as an ink having proper light absorbing performance. By arranging the light absorbing member 1153 at the chamfer 1146, light reaching the chamfer 1146 can be absorbed, preventing the light from reflecting at the chamfer 1146 to form the stray light. The interfering light and the stray light components in the image capturing module 11 are reduced, and the imaging quality of the image capturing module 11 is improved.

As shown in FIGS. 2 and 8, in some embodiments, the optical conduction element 113 further includes a third light absorbing film 1149 and a fourth light absorbing film 1151. The third light absorbing film 1149 is disposed on the first reflective surface 1132, the third light absorbing film 1149 defines the diameter of the light through aperture of the first reflective surface 1132. The fourth light absorbing film 1151 is disposed on the second reflective surface 1134 and defines the diameter of the light through aperture of the second reflective surface 1134. A material of each of the third light absorbing film 1149 and the fourth light absorbing film 1151 includes, but are not limited to, a material having proper light absorbing performance, such as ink. The third light absorbing film 1149 and the fourth light absorbing film 1151 are arranged to absorb light that reaches the first reflective surface 1132 and the second reflective surface 1134 and is located outside of the light through aperture. In this way, the light is prevented from reflecting at the first reflective surface 1132 and the second reflective surface 1134 to form the stray light, the stray light component in the image capturing module 11 is reduced, and the imaging quality of the image capturing module 11 is improved.

It is understood that a region on the first reflective surface 1132 and the second reflective surface 1134 for reflecting the light to enable the light to achieve the imaging of the image capturing module 11 can be regarded as a region of the light through aperture of the first reflective surface 1132 and the second reflective surface 1134. Light directed to the region of the light through aperture of the first reflective surface 1132 and the second reflective surface 1134 can be reflected and ultimately directed to the image sensor 112 to achieve the imaging of the image capturing module 11. It can be understood that the third light absorbing film 1149 on the first reflective surface 1132 defines a first reflective region 1133, and the fourth light absorbing film 1151 on the second reflective surface 1134 defines a second reflective region 1135. The first reflective region 1133 corresponds to the range of light through aperture of the first reflective surface 1132, and the second reflective region 1135 corresponds to the range of the light through aperture of the second reflective surface 1134. Each of the first reflective region 1133 and the second reflective region 1135 can reflect light.

It is to be noted that, by reasonably configuring angles and orientations of the first reflective surface 1132, the second reflective surface 1134 and the light transmitting surface 1136, as well as a refractive index of the body portion 1131, a light incidence angle on the light transmitting surface 1136 in which light is reflected by the first reflective surface 1132 to reach the light transmitting surface 1136 meets a demand for total reflection. In this way, light reflectivity of the light transmitting surface 1136 can be improved to enhance a light utilization efficiency and the imaging quality. However, a light incidence angle on the first reflective surface 1132 and a light incidence angle on the second reflective surface 1134 are small, and a critical angle of total reflection cannot be reached. Therefore, in order to improve the light reflectivity of the first reflective surface 1132 and the second reflective surface 1134 to improve utilization of the light and the imaging quality of the image capturing module 11, in some embodiments, a reflective film 1154 may be arranged on each of the first reflective region 1133 of the first reflective surface 1132 and the second reflective region 1135 of the second reflective surface 1134. The reflective film 1154 may improve the light reflectivity on the first reflective region 1133 and on the second reflective region 1135. The reflective film 1154 includes, but is not limited to, a metallic film layer having proper light reflective performance, which may be a silver plating.

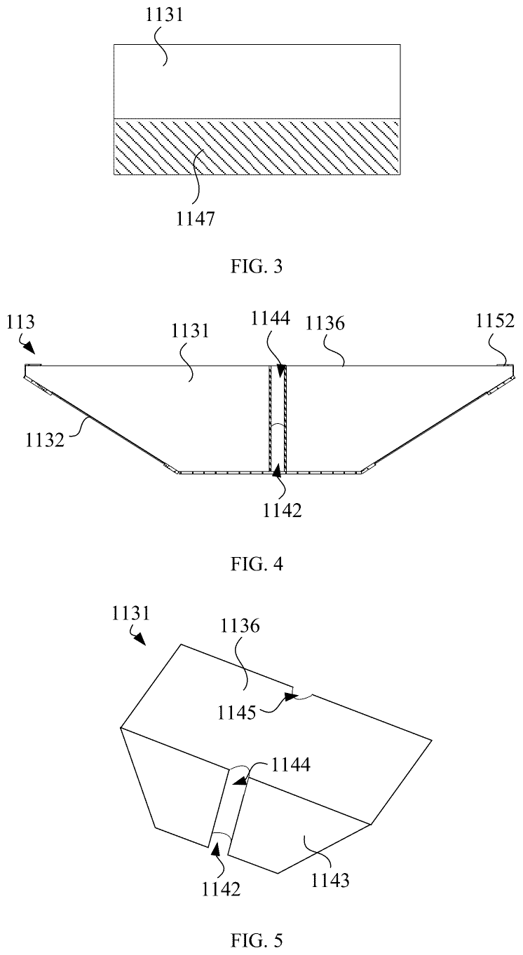

As shown in FIGS. 2 and 3, it is understood that each of the first reflective region 1133 and the second reflective region 1135 may be substantially square. When the chamfer 1146 is arranged at each of the transition between the light transmitting surface 1136 and the first reflective surface 1132 and the transition between the light transmitting surface 1136 and the second reflective surface 1134, the third light absorbing film 1149, the fourth light absorbing film 1151 and the light absorbing members 1153 arranged on the chamfers 1146 may cooperatively cover to form a substantially annular region. When the body portion 1131 is not arranged with any chamfer 1146, the third light absorbing film 1149 and the fourth light absorbing film 1151 may be arranged to be substantially annular.

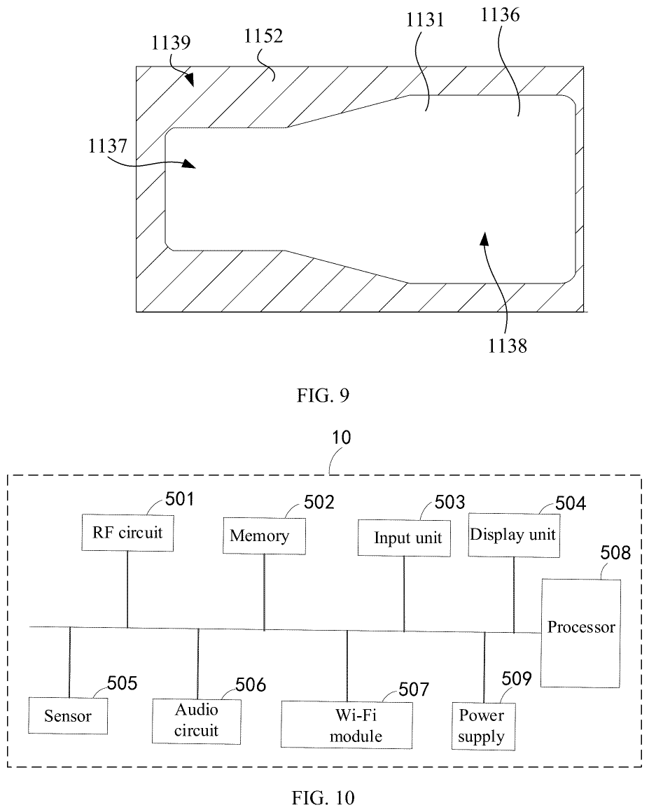

As shown in FIGS. 2 and 9, in some embodiments, the light transmitting surface 1136 is arranged with a light absorbing region 1139, which is substantially annular. The light inlet region 1137 and the light outlet region 1138 are both located within the light absorbing region 1139. The light inlet region 1137 and the light outlet region 1138 may be two adjacent regions or two regions that are spaced apart from each other and are located within the light absorbing region 1139. In some embodiments, the optical conduction element 113 may further include a fifth light absorbing film 1152 disposed in the light absorbing region 1139 covering at least a portion of the light absorbing region 1139. A material of the fifth light absorbing film 1152 includes, but is not limited to, a material having proper light absorbing performance, such as ink. The fifth light absorbing film 1152 can absorb light, which is emitted from outside of the body portion 1131 to reach the light absorbing region 1139. In this way, light is prevented from reflecting or propagating into the body portion 1131 to form the stray light. The fifth light absorbing film 1152 can also absorb light, which is emitted from an inside of the body portion 1131 onto the light absorbing region 1139. In this way, the light is prevented from reflecting to form the stray light. Therefore, the stray light component in the image capturing module 11 is reduced, and the imaging quality of the image capturing module 11 is improved.

Further, in some embodiments, a portion of the light transmitting surface 1136 corresponding to the light absorbing region 1139 is configured as the diffuse reflective surface, such as the matte surface or the frosted surface. In this way, the light reaching the light absorbing region 1139 can be diffusively reflected to reduce brightness of the light, such that the light can be absorbed by the fifth light absorbing film 1152 more easily, brightness of the light reflected in the light absorbing region 1139 is reduced, and an influence caused by the stray light on the imaging quality is reduced.

In some embodiments, the optical conduction element 113 further includes a transmittance enhancement film (not shown) covering the light inlet region 1137 and the light outlet region 1138. The transmittance enhancement film may cover a region enclosed by the light absorbing region 1139. By arranging the transmittance enhancement film, a transmittance rate that light emitted from the lens 111 passes through the light transmitting surface 1136 is increased, and a transmittance rate that light, which is emitted from the optical conduction element 113 to the image sensor 112, passes through the light transmitting surface 1136 is increased. In this way, a utilization rate of the light is improved, and brightness of the imaging is improved.

It is to be noted that, in order to facilitate distinguishing various elements, in the accompanying drawings of the present disclosure, elements having the light absorbing function are illustrated by a sectional line, such as shown in FIGS. 2-FIG. 9, each of the above-mentioned light absorbing films and light absorbing member 1153 are illustrated by the sectional line. Each of the above-mentioned light absorbing films and the light absorbing member 1153 may be formed on the body portion 1131 by performing silk screen printing or spin painting or coating.

In some embodiments, the image capturing module 11 may further include an infrared filter 116, the infrared filter 116 may be disposed between the optical conduction element 113 and the image sensor 112. The infrared filter 116 may be configured to filter out the interfering light, preventing the interfering light from being directed to the image sensor 112 and affecting normal imaging of the image capturing module 11.

As shown in FIG. 10, FIG. 10 is a structural schematic view of the electronic device 10 according to an embodiment of the present disclosure. The electronic device 10 may include a radio frequency (RF) circuit 501, a memory 502 including one or more computer-readable storage media, an input unit 503, a display unit 504, a sensor 505, an audio circuit 506, a wireless fidelity (Wi-Fi) module 507, a processor 508 including one or more processing cores, and a power supply 509. Any ordinary skilled person in the art shall understand that the structure of the electronic device 10 illustrated in FIG. 10 does not limit the electronic device 10, and the electronic device 10 may include more or fewer components than illustrated, or include combinations of certain components, or the components may be arranged in a different manner.

The RF circuit 501 is configured to send and receive information, or receive and send signals during a call, and in particular, receive downlink information from a base station and forward the downlink information to one or more processors 508 for processing. In addition, the RF circuit 501 is configured to send uplink data to the base station. Typically, the RF circuit 501 includes, but is not limited to, an antenna, at least one amplifier, a tuner, one or more oscillators, a subscriber identity module (SIM) card, a transceiver, a coupler, a low noise amplifier (LNA), a duplexer, and the like. In addition, the RF circuit 501 can communicate with networks and other devices via wireless communication. The wireless communication may use any communication standard or protocol including, but not limited to, global system of mobile communication (GSM), general packet radio service (GPRS), code division multiple access (CDMA), wideband code division multiple access (WCDMA), long term evolution (LTE), e-mail, short messaging service (SMS) and so on.

The memory 502 may be configured to store application programs and data. The application programs stored in the memory 502 include executable codes. The application programs may form various functional modules. The processor 508 performs various functional applications and data processing by running the application programs stored in the memory 502. The memory 502 may include a storage program area and a storage data area. The storage program area may store an operating system, an application program required for achieving at least one function (such as a sound playing function, an image displaying function, and so on). The storage data area may store data (such as audio data, a contact list, and so on) that are created during the electronic device 10 being in use. In addition, the memory 502 may include a high-speed random access memory, and may further include a non-volatile memory, such as at least one disk memory device, a flash memory device, or other volatile solid state memory device. Accordingly, the memory 502 may further include a memory controller to provide access to the memory 502 by the processor 508 and the input unit 503.

The input unit 503 may be configured to receive input numbers, character information, or user characteristic information (such as fingerprints), and configured to generate a keyboard signaling input, a mouse signaling input, a joystick signaling input, an optical signaling input, or a trackball signaling input related to user settings and function control. Specifically, in an embodiment, the input unit 503 may include a touch-sensing surface and other input devices. The touch-sensing surface, also referred to as a touch display or a touchpad, may collect touch operations performed by a user on or performed nearby (such as operations performed by a user on or near the touch-sensing surface using a finger, a stylus, or any other suitable object or accessory) and actuate a corresponding connected device according to a predetermined program. In some embodiments, the touch-sensing surface may include two parts, a touch detection device and a touch controller. The touch detection device detects an orientation of a touch from the user and detects a signal brought about by the touch operation, and transmits the signal to the touch controller. The touch controller receives touch information from the touch detection device and converts the touch information into contact coordinates, and then sends the contact coordinates to the processor 508, and can receive commands from the processor 508 and execute the commands.

The display unit 504 may be configured to display information entered by or provided to the user and display various graphical user interfaces of the electronic device 10. The graphical user interfaces may be formed by graphics, texts, icons, videos, and any combination thereof. The display unit 504 may comprise a display panel. In some embodiments, the display panel may be configured as a liquid crystal display (LCD), an organic light-emitting diode (OLED), or the like. Further, the touch-sensing surface may cover the display panel. When the touch-sensing surface detects the touch operation performed on or near the touch-sensing surface, the touch-sensing surface transmits the touch operation to the processor 508 to determine a type of touch event, and the processor 508 subsequently provides a corresponding visual output on the display panel based on the type of touch event. Although in FIG. 10, the touch-sensing surface and the display panel are configured as two separated components to achieve the input and output functions, in some embodiments, the touch-sensing surface and the display panel may be integrated together to achieve the input and output functions. It is understood that the display 110 may include an input unit 503 and a display unit 504.

The electronic device 10 may further include at least one sensor 505, such as a light sensor, a motion sensor, and other sensors. Specifically, the light sensor may include an ambient light sensor and a proximity sensor. The ambient light sensor may adjust brightness of the display panel based on brightness of the ambient light, and the proximity sensor may turn off the display panel and/or a backlight when the electronic device 10 is moved to an ear. As a kind of motion sensor, a gravity acceleration sensor can detect a magnitude of acceleration in each direction (generally in three axes), and the magnitude and the direction of gravity can be detected, when stationary. The magnitude and the direction of gravity may be used for: applications for recognizing a posture of the mobile phone (such as portrait and landscape screen switching, related games, magnetometer posture calibration); functions relate to vibration recognition (such as pedometer, tapping), and so on. The electronic device 10 may further be configured with a gyroscope, a barometer, a hygrometer, a thermometer, an infrared sensor and other sensors, which will not be described herein.

The audio circuit 506 may provide an audio interface between the user and the electronic device 10 via a speaker and a microphone. The audio circuit 506 may convert received audio data into electrical signals to be transmitted to the speaker, the speaker converts the electrical signals into sound signals to be output. On the other hand, the microphone converts the received sound signals into electrical signals, the electrical signals are received by the audio circuit 506 and are converted into audio data. The audio data are processed by the audio data output processor 508 to be transmitted via the radio frequency circuit 501 in order to be sent to, for example, another electronic device 10; or the audio data are output to the memory 502 for further processing. The audio circuit 506 may further include a headphone holder to provide communication between a peripheral headphone and the electronic device 10.

The Wireless fidelity (Wi-Fi) is a short-range wireless transmission technology. The electronic device 10 can assist users send and receive e-mails, browse a web, and access streaming media through the wireless fidelity module 507. The wireless fidelity module 507 provides the user with wireless access to a broadband Internet. Although the wireless fidelity module 507 is illustrated in FIG. 10, it is understood that the wireless fidelity module 507 is not a mandatory component of the electronic device 10 and can be omitted as long as the essence of the present disclosure is not changed.

The processor 508 is a control center of the electronic device 10 and is connected to various components of the electronic device 10 using various interfaces and lines. The processor 508 performs various functions of the electronic device 10 and processes data by running or executing an application program stored in the memory 502 and by invoking data stored in the memory 502, so as to monitor the electronic device 10 as a whole. In some embodiments, the processor 508 may include one or more processing core. In some embodiments, the processor 508 may integrate an application processor and a modem processor. The application processor mainly runs the operating system, the user interface, the application programs, and so on. The modem processor mainly performs the wireless communication. It is understood that the modem processor described above may alternatively not be integrated into the processor 508.

The electronic device 10 further includes a power supply 509 that supplies power to the various components. In some embodiments, the power supply 509 may be logically connected to the processor 508 via a power management system, so as to manage charging, discharging, and power consumption. The power supply 509 may further include one or more DC or AC power sources, a re-charging system, a power failure detection circuit, a power converter or inverter, a power status indicator, and any other component.

Although not shown in FIG. 10, the electronic device 10 may further include a Bluetooth module, which will not be described herein. In a specific implementation, each of the above modules may be configured as an independent entity, or may be combined in any manner as a same entity or several entities. The specific implementation of each of the above modules may be referred to the above embodiments, and will not be repeated herein.

The various technical features of the above-described embodiments can be combined in any manner, and all possible combinations of the various technical features of the above-described embodiments are not described in order to make the description concise. However, as long as there is no contradiction in combination, any combined technical solution shall be considered as being within the scope of the present disclosure.

The above-described embodiments show only several embodiments of the present disclosure, which are described in a more specific and detailed manner, but shall not be construed as a limitation of the scope of the patent disclosure. It should be noted that, any ordinary skilled person in the art may perform deformations and improvements without departing from the concept of the present disclosure, and the deformations and improvements shall fall within the scope of the present disclosure. Therefore, the scope of the present disclosure shall be subject to the attached claims.

What is claimed is:

1. An optical conduction element, comprising:
a body portion, having a light transmitting surface, a first reflective surface, a second reflective surface, and a bottom surface, wherein the light transmitting surface has a light inlet region and a light outlet region; the first reflective surface is inclined with respect to the light transmitting surface and is disposed corresponding to the light inlet region; the second reflective surface is inclined with respect to the light transmitting surface and is disposed corresponding to the light outlet region; the bottom surface is connected to the first reflective surface and the second reflective surface and is opposite to the light transmitting surface; the bottom surface defines a first groove; and
a first light absorbing film, covering at least two opposite side walls of the first groove.

2. The optical conduction element according to claim 1, wherein each of the two side walls of the first groove is configured as a diffuse reflective surface.

3. The optical conduction element according to claim 1, wherein, the body portion further has two end surfaces opposite to each other; each of the two end surfaces are connected to the first reflective surface and the second reflective surface; the bottom surface is connected to the two end surfaces; one of the two end surfaces defines a second groove, the other one of the two end surfaces defines a third groove; each of the second groove and the third groove is extending in a direction from the bottom surface towards the light transmitting surface.

4. The optical conduction element according to claim 3, wherein two ends of the first groove are respectively communicated to the second groove and the third groove; the first groove, the second groove and the third groove cooperatively define a light through aperture of the body portion.

5. The optical conduction element according to claim 3, wherein the first light absorbing film further covers at least a side wall of the second groove and a side wall of the third groove; each of the side wall of the second groove and the side wall of the third groove is configured to have a diffuse reflective surface.

6. The optical conduction element according to claim 3, wherein each of a width of the first groove, a width of the second groove and a width of the third groove is in a range of 0.2 mm to 0.8 mm.

7. The optical conduction element according to claim 3, wherein, the first groove extends in an extending direction of a connection line between the two end surfaces; a depth of the first groove occupies ¼ to ½ of a height of the optical conduction element; a depth of the second groove and a depth of the third groove occupy ¼ to ⅓ of a length of the optical conduction element.

8. The optical conduction element according to claim 1, further comprising a second light absorbing film, wherein the second light absorbing film covers at least a portion of the bottom surface, and the at least the portion of the bottom surface is a diffuse reflective surface.

9. The optical conduction element according to claim 1, wherein a chamber is configured at a transition between the light transmitting surface and the first reflective surface, and another chamber is configured at a transition between the light transmitting surface and the second reflective surface; the optical conduction element further comprises: a light absorbing member covering the chamber and another light absorbing member covering the another chamber.

10. The optical conduction element according to claim 1, further comprising a third light absorbing film and a fourth light absorbing film, wherein the third light absorbing film is disposed on the first reflective surface to define a light through aperture of the first reflective surface, and the fourth light absorbing film is disposed on the second reflective surface to define a light through aperture of the second reflective surface.

11. The optical conduction element according to claim 10, wherein the third light absorbing film is disposed on the first reflective surface and encloses to define a first reflective region; the fourth light absorbing film is disposed on the second reflective surface and encloses to define a second reflective region; the optical conduction element further comprises a first reflective film disposed in the first reflective region and a second reflective film disposed in the second reflective region.

12. The optical conduction element according to claim 1, wherein the light transmitting surface is arranged with a light absorbing region, which is substantially annular; the light inlet region and the light outlet region are both located within the light absorbing region; the optical conduction element further comprises a fifth light absorbing film covering the light absorbing region; the light absorbing region of the light transmitting surface is configured as a diffuse reflective surface; the optical conduction element further comprises a transmittance enhancing film covering at least the light inlet region and the light outlet region.

13. The optical conduction element according to claim 1, wherein, each of an angle between the first reflective surface and the bottom surface and an angle between the second reflective surface and the bottom surface is in a range of 25° to 35°, the optical conduction element has a refractive index of 1.5 to 1.9.

14. An image capturing module, comprising a lens, an image sensor, and an optical conduction element;
wherein, the optical conduction element comprises:
a body portion, having a light transmitting surface, a first reflective surface, a second reflective surface, and a bottom surface, wherein the light transmitting surface has a light inlet region and a light outlet region; the first reflective surface is inclined with respect to the light transmitting surface and is disposed corresponding to the light inlet region; the second reflective surface is inclined with respect to the light transmitting surface and is disposed corresponding to the light outlet region; the bottom surface is connected to the first reflective surface and the second reflective surface and is opposite to the light transmitting surface; the bottom surface defines a first groove; and
a first light absorbing film, covering at least two opposite side walls of the first groove;
wherein a light outlet side of the lens is disposed corresponding to the light inlet region, and the image sensor is disposed corresponding to the light outlet region.

15. The image capturing module according to claim 14, wherein each of the two side walls of the first groove is configured as a diffuse reflective surface.

16. The image capturing module according to claim 14, wherein the body portion further has two end surfaces opposite to each other; each of the two end surfaces are connected to the first reflective surface and the second reflective surface; the bottom surface is connected to the two end surfaces; one of the two end surfaces defines a second groove, the other one of the two end surfaces defines a third groove; each of the second groove and the third groove is extending in a direction from the bottom surface towards the light transmitting surface.

17. The image capturing module according to claim 16, wherein two ends of the first groove are respectively communicated to the second groove and the third groove; the first groove, the second groove and the third groove cooperatively define a light through aperture of the body portion.

18. The image capturing module according to claim 16, wherein the first light absorbing film further covers at least a side wall of the second groove and a side wall of the third groove; each of the side wall of the second groove and the side wall of the third groove is configured to have a diffuse reflective surface.

19. The image capturing module according to claim 14, wherein the optical conduction element further comprises a second light absorbing film, wherein the second light absorbing film covers at least a portion of the bottom surface, and the at least the portion of the bottom surface is a diffuse reflective surface.

20. An electronic device, comprising a housing and an image capturing module,
wherein, the image capturing module comprises a lens, an image sensor, and an optical conduction element; and the optical conduction element comprises:
a body portion, having a light transmitting surface, a first reflective surface, a second reflective surface, and a bottom surface, wherein the light transmitting surface has a light inlet region and a light outlet region; the first reflective surface is inclined with respect to the light transmitting surface and is disposed corresponding to the light inlet region; the second reflective surface is inclined with respect to the light transmitting surface and is disposed corresponding to the light outlet region; the bottom surface is connected to the first reflective surface and the second reflective surface and is opposite to the light transmitting surface; the bottom surface defines a first groove; and
a first light absorbing film, covering at least two opposite side walls of the first groove;
wherein a light outlet side of the lens is disposed corresponding to the light inlet region, and the image sensor is disposed corresponding to the light outlet region; and
wherein the image capturing module is disposed inside the housing, the housing defines a light inlet hole, the light inlet hole is disposed corresponding to the light inlet side of the lens.
